(19) United States
(12) Patent Application Publication
(10) Pub. No.: US 2024/0420167 A1
(43) Pub. Date: Dec. 19, 2024

(54) TECHNIQUES FOR INSIGHT QUANTIZATION AND STATE CONTROL

(71) Applicant: Wells Fargo Bank, N.A., San Francisco, CA (US)

(72) Inventors: Rameshchandra Bhaskar Ketharaju, Hyderabad (IN); Ashutosh Verma, Bangalore (IN); Ramesh Babu Sarvesetty, Bangalore (IN)

(21) Appl. No.: 18/334,178

(22) Filed: Jun. 13, 2023

(51) Int. Cl. G06Q 30/0202

(52) U.S. Cl. CPC G06Q 30/0202

(57) ABSTRACT

Various embodiments are generally directed to insight quantization and state control, such as in the context of CRM. Some embodiments are particularly directed to forecasting and avoiding or diffusing user issues, such as customer complaints, associated with enterprises and enterprise systems. For example, embodiments include utilizing insight indexes to quantize user states, determining a likelihood for issues to arise based on the quantized insight indexes, and performing a state improvement process when the likelihood for issues arises. The state improvement process may generate and/or implement mediating output actions configured to adjust the quantized insight indexes and reduce the likelihood for issues to arise.

### FIELD OF DISCLOSURE

This disclosure relates generally to digital data processing, modeling, and communication systems and more particularly to insight quantization and state control in enterprise system interactions.

### BACKGROUND

Enterprise systems generally refer to a collection of tools, procedures, and computer programs that seeks to satisfy the needs of an enterprise. For example, enterprise systems may be directed to the display, manipulation, and storage of large amounts of often complex data and the support or automation of business processes with that data. Oftentimes, enterprise systems perform one or more business functions, such as order processing, procurement, production scheduling, customer relationship management, customer information management, energy management, and accounting. Customer relationship management (CRM) typically refers to a process in which a business or other organization administers interactions with customers and/or potential customers.

CRM systems may compile data from a range of different communication channels, including a company's website, telephone, email, live chat, marketing materials and more recently, social media. CRM systems may allow businesses to learn more about their target audiences and how to best cater to their needs, thus retaining customers and driving sales growth. CRM may be used with past, present or potential customers. The concepts, procedures, and rules that a corporation follows when communicating with its consumers are referred to as CRM.

### BRIEF SUMMARY

Processes, machines, and articles of manufacture for supporting insight quantization and state control are described. It will be appreciated that the embodiments may be combined in any number of ways without departing from the scope of this disclosure. For example, components illustrated as part of one component may be incorporated into another component without departing from the scope of this disclosure.

Embodiments may include determining a context of a user with respect to an enterprise system; selecting a quantized insight index relevant to a current situation of the user based on the context of the user; monitoring values of a set of indicators corresponding to the quantized insight index and the user; generating a current value of the quantized insight index for the user based on current values of the set of indicators corresponding to the quantized insight index; triggering a performance of a state improvement process in response to comparison of the current value of the quantized insight index to the trigger threshold, the performance of the state improvement process including: utilizing the current value of the quantized insight index as input to forecast an issue, generating a mediating output action configured to adjust the current value of the quantized insight index and reduce or avoid the issue, and implementing the mediating output action; updating values of the set of parameters corresponding to the user of the enterprise system; generating an updated value of the quantized insight index based on updated values of the set of indicators corresponding to the quantized insight index; and determining performance of another state improvement process is unnecessary in response to comparison of the updated value of the quantized insight index to the trigger threshold.

Other processes, machines, and articles of manufacture are also described hereby, which may be combined in any number of ways, such as with the embodiments of the brief summary, without departing from the scope of this disclosure.

### BRIEF DESCRIPTION OF THE DRAWINGS

The present disclosure is illustrated by way of example and not limitation in the figures of the accompanying drawings in which like references indicate similar elements. To easily identify the discussion of any particular element or act, the most significant digit or digits in a reference number refer to the figure number in which that element is first introduced.

FIG. 1 illustrates an exemplary operating environment for an insight quantization and state control (IQSC) system according to one or more embodiments.

FIG. 2 illustrates exemplary aspects of an IQSC system according to one or more embodiments.

FIG. 3 illustrates exemplary aspects of a state monitor according to one or more embodiments.

FIG. 4 illustrates exemplary aspects of an insight quantizer according to one or more embodiments.

FIG. 5 illustrates exemplary aspects of knowledge base manager according to one or more embodiments.

FIG. 6 illustrates exemplary aspects of an issue forecaster according to one or more embodiments.

FIG. 7 illustrates exemplary aspects of an IQSC administrator according to one or more embodiments.

FIG. 8 illustrates an exemplary process flow corresponding to an IQSC system according to one or more embodiments.

FIG. 9 illustrates an exemplary process diagram corresponding to an IQSC system according to one or more embodiments.

FIG. 10 illustrates exemplary aspects of a computing system according to one or more embodiments described hereby.

FIG. 11 illustrates exemplary aspects of a communications architecture according to one or more embodiments described hereby.

### DETAILED DESCRIPTION

Various embodiments are generally directed to techniques for insight quantization and state control, such as in the context of CRM. Some embodiments are particularly directed to forecasting and avoiding or diffusing user issues, such as customer complaints, associated with enterprises and enterprise systems. For example, embodiments include utilizing insight indexes to quantize user states, determining a likelihood for issues to arise based on the quantized insight indexes, and performing a state improvement process when the likelihood for issues arises. The state improvement process may generate and/or implement mediating output actions configured to adjust the quantized insight indexes and reduce the likelihood for issues to arise. These and other embodiments are described and claimed.

Many challenges face enterprise systems, such as with regard to CRM systems. For example, CRM systems may provide overarching guidance. However, they lack the ability to provide interaction specific guidance and/or automated actions to avoid or diffuse user specific issues in dynamic and/or real-time situations. Oftentimes, the inability provide interaction specific guidance and/or automated actions results from not being able to accurately quantize a user state in a reliable and real-time or near real-time manner. Additionally, the inability provide interaction specific guidance and/or automated actions frequently results from an inability to forecast potential issues and utilize mediating actions to control user state and avoid issues. Adding further complexity, existing systems cannot generalize user specific issues in a manner that can enable other users to benefit from the user specific issues. This can result from an inability of existing systems to identify common root causes among various specific issues and determine actions to reduce or eliminate the root cause. Such limitations can drastically reduce the usability and applicability of enterprise and/or CRM systems, contributing to inefficient systems, devices, and techniques with limited capabilities.

Embodiments described hereby include an insight quantization and state control (IQSC) system that provides situational awareness and interaction specific guidance and/or automated actions to avoid or diffuse user specific issues in dynamic and/or real-time situations. In doing so, IQSC may provide computing systems with new functionality, such as quantized insight indexes that dynamically respond and adapt to unique and evolving situations to improve user experiences and user satisfaction by controlling the state of the user. In many embodiments, quantized insight indexes may be utilized for ranking and scoring user states (e.g., amount of remaining patience). In many such embodiments, the quantized insight indexes may be utilized to identify tipping points of users, such as when a user enters an emotional state in which they are likely to raise a complaint. Further, trigger thresholds may be set based on identified tipping points. The trigger thresholds may trigger performance of a state improvement process to avoid or mediate the identified tipping points.

In many embodiments, the state improvement process may forecast issues and determine avoidance or mediation actions based, at least in part, on the quantized insight indexes and a historical knowledge base. In various such embodiments, the state improvement process may include controlling one or more components of an enterprise system to implement avoidance or mediation actions. In several embodiments, potential issues may be forecasted, such as based on the insight indexes. In several such embodiments, mediating actions may be identified and/or implemented to avoid or reduce potential issues. Many embodiments include intelligence that converts historical data into insights and wisdom based on the insight indexes and a knowledge base. In some embodiments, root causes of issues may be identified and generalized in a manner that enables others to benefit, such as by removing or reducing a root cause that manifests as multiple different issues.

In these and other ways, components/techniques described hereby may be utilized to improve insight quantization and state control, resulting in several technical effects and advantages over conventional computer technology, including increased capabilities and improved performance. For example, the IQSC system may enable monitoring and control of components of an enterprise system to state control actions. Many embodiments may provide interaction specific guidance and/or automated actions to avoid or diffuse user specific issues in dynamic and/or real-time situations. Several embodiments may accurately quantize a user state in a reliable and real-time or near real-time manner. Many embodiments provide the ability to forecast potential issues and utilize mediating actions to control user state and avoid issues. For instance, behavioral modeling and/or perceptual control techniques may be utilized in monitoring, quantizing, and controlling user states. Some embodiments generalize user specific issues in a manner that can enable other users to benefit from the user specific issues, such as by identifying common root causes among various specific issues and determining actions to reduce or eliminate the root cause. In many embodiments, generalization of specific issues may be utilized identify and proactively remedy potential issues for other users to control their states. Additional technical effects and advantages over conventional computer technology and technical fields will be apparent from the detailed description below.

One or more of the aspects, techniques, and/or components described hereby may be implemented in a practical application via one or more computing devices, and thereby provide additional and useful functionality to the one or more computing devices, resulting in more capable, better functioning, and improved computing devices. For example, a practical application may improve the technical process of one or more of insight quantization and state control. In another example, enterprise system components may be monitored and/or controlled, such as to perform state control processes or gain situational awareness. In yet another example, accurate and reliable quantization of insights may enable situations and issues to be forecast and avoided or mediated. In yet another example, root-cause analyses may be performed on situations and utilized to benefit other users. Additional examples will be apparent from the description above and below. Further, one or more of the aspects, techniques, and/or components described hereby may be utilized to improve the technical fields of insight quantization, behavioral modeling, perceptual control, state control, CRM, and enterprise component control.

In several embodiments, components described hereby may provide specific and particular manners to enable improved BDD testing. In many embodiments, one or more of the components described hereby may be implemented as a set of rules that improve computer-related technology by allowing a function not previously performable by a computer that enables an improved technological result to be achieved. For example, the function allowed may include one or more of the specific and particular techniques disclosed hereby such as for quantizing insights and controlling states. Additional examples will be apparent from the description above and below.

Reference is now made to the drawings, wherein like reference numerals are used to refer to like elements throughout. In the following description, for purposes of explanation, numerous specific details are set forth in order to provide a thorough understanding thereof. However, the novel embodiments can be practiced without these specific details. In other instances, structures and devices are shown in block diagram form in order to facilitate a description thereof. The intention is to cover all modifications, equivalents, and alternatives consistent with the claimed subject matter. Aspects of the disclosed embodiments may be described with reference to one or more of the following figures. Some of the figures may include a logic flow and/or a process flow. Although such figures presented herein may include a particular logic or process flow, it can be appreciated that the logic or process flow merely provides an example of how the general functionality as described herein can be implemented. Further, a given logic or process flow does not necessarily have to be executed in the order presented unless otherwise indicated. Moreover, not all acts illustrated in a logic or process flow may be required in some embodiments. In addition, a given logic or process flow may be implemented by a hardware element, a software element executed by a processor, or any combination thereof.

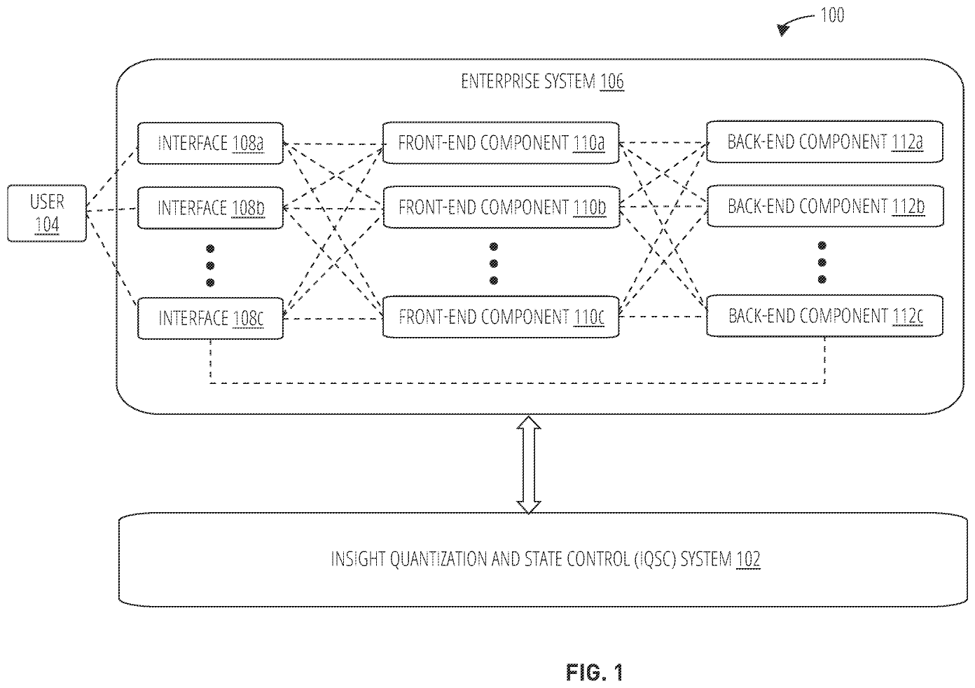

FIG. 1 illustrates an operating environment 100 for an IQSC system 102 according to some embodiments. Generally, the IQSC system 102 may operate to utilize one or more insight indexes to quantize user states, determine a likelihood for issues to arise based on the quantized insight indexes, and perform a state improvement process to control the user state when the likelihood for issues arises. In the illustrated embodiment, the operating environment 100 includes the IQSC system 102, a user 104, and an enterprise system 106. The enterprise system 106 includes one or more interfaces 108a, 108b, 108c (collectively referred to as interfaces 108), one or more front-end components 110a. 110b, 110c (collectively referred to as front-end components 110), and one or more back-end components 112a, 112b, 112c (collectively referred to as back-end components 112), It will be appreciated that one or more components of FIG. 1 may be the same or similar to one or more other components disclosed hereby. Further, aspects discussed with respect to various components in FIG. 1 may be implemented by one or more other components from one or more other embodiments without departing from the scope of this disclosure. Embodiments are not limited in this context.

In various embodiments, the IQSC system 102 monitors customer transactions in real time, score/predicts customer complaints, and manages complaint resolution, including prioritization of resolutions and deployment of measures in real time. The IQSC system 102 may operate to selectively monitor and/or control one or more of interfaces 108, front-end components 110, and back-end components 112 of enterprise system 106 to implement one or more techniques disclosed hereby, such as quantizing insights and controlling states. For example, IQSC system 102 may monitor indicator values associated with operational parameters of enterprise system 106 to quantize insights regarding user 104. In an additional, or further, example, the IQSC system 102 may utilize monitoring and/or control of components of the enterprise system 106 to perform state improvement processes. In some embodiments, state improvement processes may include one or more of forecasting issues, generating mediating output actions, and implementing mediating output actions. The mediating output actions may be configured to one or more of reduce an issue, avoid an issue, improve quantized insights, and control states. In many embodiments, IQSC system 102 may control operational of aspects of the enterprise system 106 to implement mediating output actions.

Interfaces 108 may include one or more components that enable or facilitate interacting with users (e.g., user 104). For example, interfaces 108 may be utilized to access one or more front-end components 110. In one embodiment, IQSC system 102 may utilize interfaces 108 to route users to the appropriate front-end component. In some embodiments, IQSC system 102 may route interactions, data, and the like through a selective set of interfaces 108, front-end components 110 and/or back-end components 112. For example, IQSC system 102 may route a user 104 to a specific interface identified based on data on the user 104 (e.g., previous interactions, profile, previous complaints, time spent waiting, etcetera). In various embodiments, interfaces 108 may include one or more of a phone, networking components (e.g., router, switch, access point), sensors (e.g., biometric scanner, camera, biometric monitor, environmental sensors (e.g., temperature, noise, humidity), speakers, displays, card readers, application programming interfaces, a point of sale device, enterprise personnel (e.g., sales agent, marketing person, managers, customer service representatives (CSRs), and the like).

Front-end components 110 may include one or more components that are user facing systems. For example, the front-end components 110 may be utilized to access enterprise services and/or purchase enterprise products. In various embodiments, IQSC system 102 may control the information provided (e.g., displayed) to users through front-end components. For example, the IQSC system 102 may offer discounted products or selected communications channels based on data on the user 104 (e.g., previous interactions, profile, previous complaints, time spent waiting, etcetera). In some embodiments, IQSC system 102 may instantiate one or more interfaces 108, front-end components 110, and/or back-end components 112. In various embodiments, the front-end components 110 may include one or more of a website, an application, a telephony system, a service distribution system (e.g., streaming service), a call center, a customer service system, a CRM system, a point of sale manager, and the like.

Back-end components 112 may include one or more components that are enterprise personnel facing systems. For example, the back-end components 112 may be utilized for user data management, inventory tracking, historical data management, a customer service system, a CRM system, a point of sale manager, scheduling, ordering, and the like. In various embodiments, IQSC system 102 may control aspects of the back-end components, such as by updating user data, collecting data (e.g., for producing training data or generating recommendations or suggested actions). In various embodiments, the IQSC system 102 may install or deploy agents into the enterprise system 106 for monitoring and/or control purposes. Although the IQSC system 102 and enterprise system 106 are illustrated as separate components, in several embodiments, the IQSC system 102 may comprise one or more components of the enterprise system 106. For example, IQSC system 102 may comprise a back-end component of enterprise system 106.

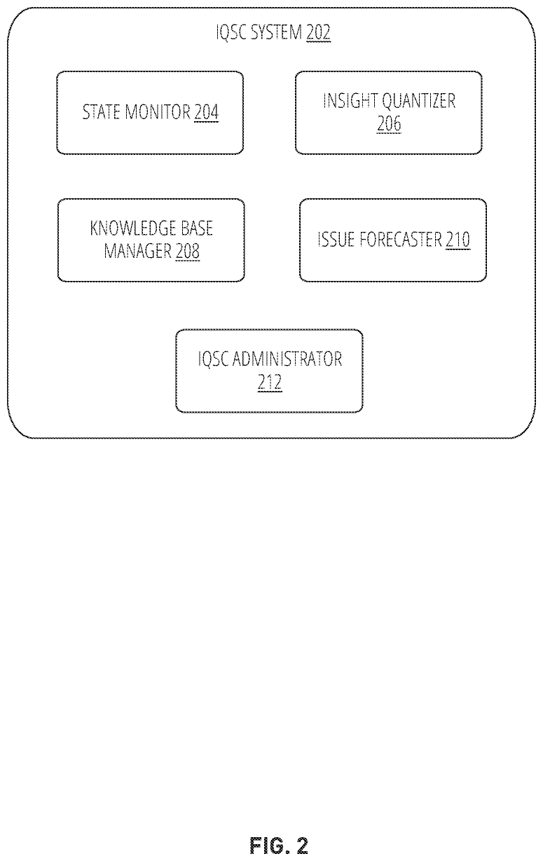

FIG. 2 illustrates exemplary aspects of an IQSC system 202 according to some embodiments. In the illustrated embodiment, the IQSC system 202 includes a state monitor 204, an insight quantizer 206, a knowledge base manager 208, an issue forecaster 210, and an IQSC administrator 212. Generally, the components of the IQSC system 202 may interoperate to provide insight quantization and state control. For example, the state monitor 204 may monitor interactions between a user and one or more components of an enterprise system, the insight quantizer 206 may quantize the current state of the user using one or more insight indexes, the knowledge base manager 208 may analyze and filter relevant historical data to identify data relevant to the current state of the user and/or root causes of issues, the issue forecaster 210 may forecast potential issues and/or set trigger thresholds, and the IQSC administrator 212 may track issues, implement mediating actions, and log resolutions. It will be appreciated that one or more components of FIG. 2 may be the same or similar to one or more other components disclosed hereby. For example, IQSC system 202 may be the same or similar to IQSC system 102. Further, aspects discussed with respect to various components in FIG. 2 may be implemented by one or more other components from one or more other embodiments without departing from the scope of this disclosure. Embodiments are not limited in this context.

The IQSC system 202 may operate to provide situational awareness and interaction specific guidance and/or automated actions to avoid or diffuse user specific issues in dynamic and/or real-time situations. In doing so, the IQSC system 202 may utilize quantized insight indexes that dynamically respond and adapt to unique and evolving situations to improve user experiences and user satisfaction by controlling the state of the user. In many embodiments, the IQSC system 202 monitors customer transactions in real time, score/predicts customer complaints, and manages complaint resolution, including prioritization of resolutions and deployment of measures in real time.

The state monitor 204 may monitor various operational parameters including data collected by the enterprise system on a user and contextual data. In some embodiments, state monitor 204 may deploy agents (e.g., a key logger) into the enterprise system to monitor and/or control enterprise system components. For example, state monitor 204 may monitor values of selective sets of indicators associated with or corresponding to users. In one such example, the state monitor 204 may monitor a wait time, a user temperature (e.g., via a thermal scanner), and an environmental noise level.

The insight quantizer 206 may utilize the indicators to quantize insights on users, such as by generating quantized insight indexes. Further, the insight quantizer 206 may distill context (e.g., context of users) from data received from state monitor 204. The insight quantizer 206 may utilize data from one or more other components of the enterprise system and/or the IQSC system 202. In many embodiments, quantized insight indexes may be utilized by components of the IQSC system 202 for ranking and scoring user states (e.g., amount of remaining patience). In many such embodiments, the quantized insight indexes may be utilized, such as by issue forecaster 602, to identify tipping points of users, such as when a user enters an emotional state in which they are likely to raise a complaint. Further, trigger thresholds may be set based on identified tipping points. The trigger thresholds may trigger performance of a state improvement process to avoid or mediate the identified tipping points.

The knowledge base manager 208 may maintain and analyze historical data to provide analytics (e.g., on relevant, appropriate, and/or recommended trigger thresholds, sets of indicators, sets of insight indexes, output actions, and the like). In some embodiments, knowledge base manager 208 may filter relevant data that corresponds to a specific situation, such as based on quantized insight indexes, contextual data, and/or user data. In some such embodiments, knowledge base manager 208 may provide the relevant data to other components (e.g., insight quantizer 206, issue forecaster 210, or IQSC administrator 212). The knowledge base manager 208 may utilize data from one or more other components of the enterprise system and/or the IQSC system 202. In various embodiments, knowledge base manager 208 may perform root-cause analysis.

The issue forecaster 210 may operate to predict issues and determine relevant, appropriate, and/or recommended trigger thresholds, sets of indicators, sets of insight indexes, output actions, and the like). The issue forecaster 210 may utilize data from one or more other components of the enterprise system and/or the IQSC system 202. The IQSC administrator 212 may track issues, implement mediating actions, and log resolutions.

FIG. 3 illustrates exemplary aspects of a state monitor 302 according to some embodiments. Generally, the state monitor 302 may monitor interactions between a user and one or more components of an enterprise system. In some embodiments, the state monitor 302 may generate simulated data, such as for testing various aspects of the IQSC system 102. In the illustrated embodiment, the state monitor 302 includes an alerts manager 304, an experience manager 306, a service time manager 308, a service level agreement (SLA) manager 310, and a state simulator 312. It will be appreciated that one or more components of FIG. 3 may be the same or similar to one or more other components disclosed hereby. For example, state monitor 302 may be the same or similar to state monitor 204. Further, aspects discussed with respect to various components in FIG. 3 may be implemented by one or more other components from one or more other embodiments without departing from the scope of this disclosure. Embodiments are not limited in this context.

The state monitor 204 may utilize a variety of sensors to collect and analyze data on one or more of users, user interactions, environments, contexts, and the like. For example, experience manager 306 may utilize sensors included in an enterprise system to collect data for generating quantized insight indexes relevant to a current situation of a user. In various examples, the experience manager 306 may generate indicator values based on the collected data. For example, experience manager 306 may generate an indicator value for a user by performing expression-based image-recognition analysis on video sensor data. In another example, experience manager 306 may generate an indicator value for a user by analyzing pitch or tone of the voice of a user. In one such embodiment, the experience manager 306 may compare the pitch and/or tone of a user to historical pitch or tones associated with the user. In an additional, or other, such embodiment, the experience manager 306 may compare changes (i.e., the delta) in pitches and/or tones with the changes in pitches and/or tones of other users associated with having issues. In yet another example, the experience manager 306 may generate an indicator value for a user based on thermal imaging, such as an indicator value corresponding to user temperature. Similarly, changes in user temperature may be utilized to generate indicator values.

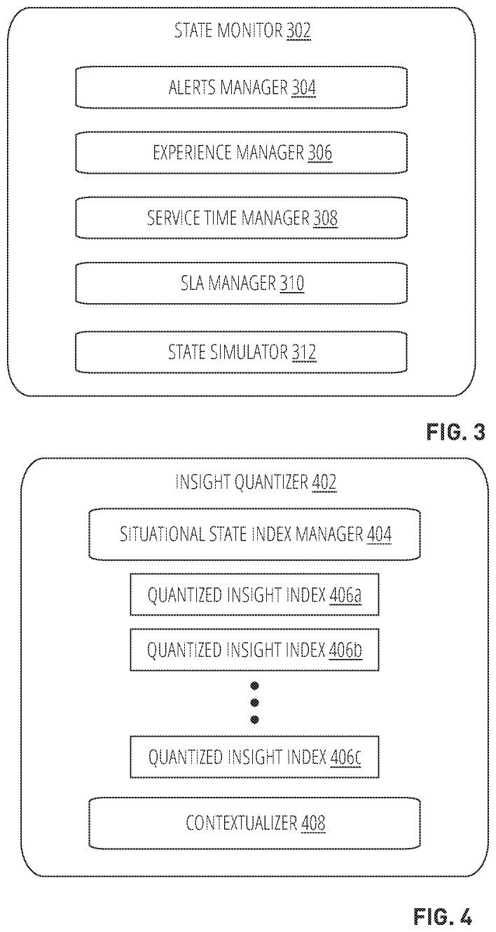

In some embodiments, the periodicity between various user parameters may be utilized to determine indicator values (such as based on historical comparisons). For example, the rate at which a user provides input may be utilized to generate an indicator value. In such examples, the experience manager 306 may utilize a key logger to monitor user input. For instance, increased typing rates, typing errors, and/or deletions may indicate increased user frustration. In various embodiments, the grammar of inputs may be utilized for generating indicator values. For example, increases in capitalization and exclamation marks may indicate dwindling user patience. As will be discussed in more detail, such as with respect to FIG. 4, select sets of these indicators may be utilized to generate or determine one or more values for one or more quantized insight indexes.

In many embodiments, experience manager 306 may utilize data and/or indications from one or more other components of state monitor 302. For example, an indicator value may be based on alert data generated by alerts manager 304. In another example, one or more of alerts manager 304, experience manager 306, service time manager 308, and SLA manager 310 may utilize data generated by state simulator 312. In some embodiments, state simulator 312 may generate simulated data correlated with historically collected data. In one embodiment, state simulator 312 may be utilized to anonymize historically collected data. In various embodiments, state simulator 312 may be utilized to generate training data for one or more embodiments described hereby. For example, training data may include one or more key-value pairs corresponding to indicators and/or insight indexes and historical values. In another example, training data may include multidimensional data with various dimensions corresponding to various indicators and/or insight indexes. In many embodiments, state simulator 312 may generate training data for one or more components of one or more of state monitor 204, insight quantizer 206, knowledge base manager 208, issue forecaster 210, and IQSC administrator 212.

In several embodiments, experience manager 306 may utilize one or more similar procedures utilized to determine indicator values to determine contextual and/or environmental data. In several such embodiments, the contextual and/or environmental data may be utilized to determine indicator values, user contexts, and/or user environments. For example, ambient temperature or ambient noise levels may be utilized to determine user environment for generating indicator values. In another example, data on prior interactions of the user with various components of an enterprise system may be utilized to determine context data including a current situation of a user and what lead to the current situation (e.g., a series of steps, interactions, associated components, corresponding interfaces, corresponding front-end components, corresponding back-end components, and the like. In some embodiments, the context of the user includes one or more of a product type, a service type, an interface type, a transaction type, and a front-end component type.

Additionally, or alternatively, the state monitor 204 may monitor a variety of operational, system, and/or data parameters (e.g., corresponding to one or more enterprise system components). For example, the alerts manager 304 may be utilized to monitor for instances of alerts associated with users. In another example, the service time manager 308 may be utilized to initialize, start, stop, and/or monitor one or more timers, such as timers associated with wait times, duration between inputs, servicing time, historical times, cumulative times, and the like. In yet another example, the SLA manager 310 may be utilized to monitor adherence to service level agreements, such as with respect to interactions with users, quality of service, services provided, levels of service provided, privileges, and the like.

In some embodiments, state monitor 302, or other components, such as IQSC administrator 212, may deploy agents (e.g., a key logger, a traffic monitor, and the like) into various components of the enterprise system to monitor and/or control enterprise system components. In various embodiments, components may utilize backdoors and/or privilege escalation to commandeer operational aspects of system components. In one embodiment, state monitor 302 may control the operations of one or more components to collect data for generating indicator values or the like. For example, state monitor 302 may control where a camera is pointing to collect data for generating indicator values.

FIG. 4 illustrates exemplary aspects of an insight quantizer 402 according to some embodiments. Generally, the insight quantizer 402 may quantize the current state of users using one or more insight indexes. In the illustrated embodiment, the insight quantizer 402 includes a situational state index manager 404, one or more quantized insight indexes 406a, 406b, 406c (collectively referred to as quantized insight indexes 406), and a contextualizer 408. It will be appreciated that one or more components of FIG. 4 may be the same or similar to one or more other components disclosed hereby. For example, insight quantizer 402 may be the same or similar to insight quantizer 206. Further, aspects discussed with respect to various components in FIG. 4 may be implemented by one or more other components from one or more other embodiments without departing from the scope of this disclosure. Embodiments are not limited in this context.

The situational state index manager 404 may utilize data and values, such as for indicators, from state monitor 302 to determine one or more quantized insight index values for a user. Further, situational state index manager 404 may utilize data and values from one or more other components in addition to, or in alternative to, state monitor 302 to determine quantized insight index values. For example, data from knowledge base manager 208 and/or issue forecaster 210 may be utilized. In many embodiments, situational state index manager 404 may determine relevant quantized insight indexes and/or corresponding sets of indicators for use with respect to a user. In many such embodiments, situational state index manager 404 may determine relevant quantized insight indexes and/or corresponding sets of indicators for use with respect to a user, such as based on input from one or more of state monitor 204, knowledge base manager 208, issue forecaster 210, and/or IQSC administrator 212. In various embodiments, situational state index manager 404 and/or contextualizer 408 may direct operation of state monitor 302 (e.g., by indicating what values to monitor for various users).

Similarly, contextualizer 408 may utilize data and value from various components to determine a context of a user 104. In some embodiments, contextualizer 408 may distill context from data received from state monitor 302. In many embodiments, quantized insight indexes may be utilized by components of the IQSC system for ranking and scoring user states (e.g., amount of remaining patience), forecasting issues, generating mediating output actions, determining thresholds, and the like. For example, the quantized insight index values and/or context of a user may be utilized, such as by issue forecaster 602, to identify tipping points of users, such as when a user enters an emotional state in which they are likely to raise a complaint. Further, trigger thresholds may be set based on identified tipping points. The trigger thresholds may trigger performance of a state improvement process to avoid or mediate the identified tipping points.

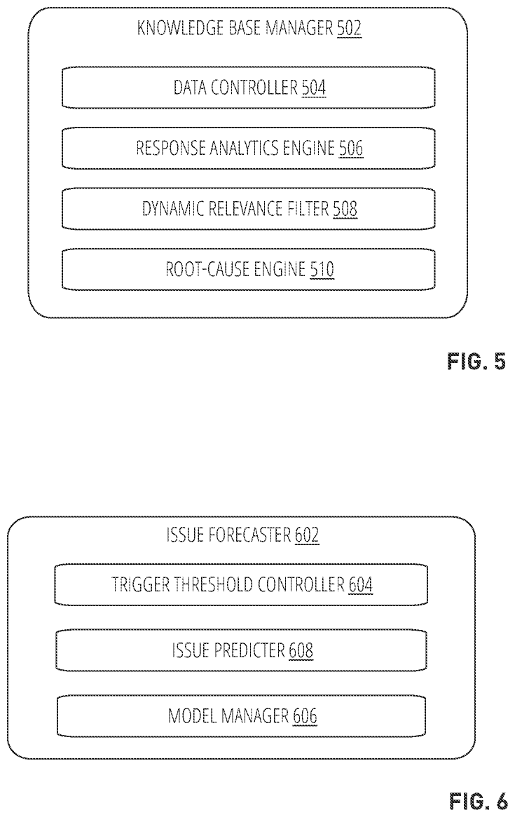

FIG. 5 illustrates exemplary aspects of a knowledge base manager 502 according to some embodiments. Generally, the knowledge base manager 502 may analyze and filter relevant historical data to identify data relevant to the current state of the user and/or root causes of issues. In the illustrated embodiment, the knowledge base manager 502 includes a data controller 504, a response analytics engine 506, a dynamic relevance filter 508, and a root-cause engine 510. It will be appreciated that one or more components of FIG. 5 may be the same or similar to one or more other components disclosed hereby. For example, knowledge base manager 502 may be the same or similar to knowledge base manager 208. Further, aspects discussed with respect to various components in FIG. 5 may be implemented by one or more other components from one or more other embodiments without departing from the scope of this disclosure. Embodiments are not limited in this context.

Components of the knowledge base manager 208 may maintain and analyze historical data to provide analytics (e.g., on relevant, appropriate, and/or recommended trigger thresholds, sets of indicators, sets of insight indexes, output actions, and the like), identification of relevant data, and root-cause analysis. In various embodiments, response analytics engine 506 may generate analytics based on historical and/or current data. In various such embodiments, the analytics may be utilized by the dynamic relevance filter 508.

The dynamic relevance filter 508 may filter relevant data that corresponds to a specific situation, such as based on quantized insight indexes, contextual data, and/or user data. In some such examples, dynamic relevance filter 508 may provide the relevant data to other components (e.g., insight quantizer 206, issue forecaster 210, or IQSC administrator 212). The knowledge base manager 502 may collect and utilize data from one or more other components of the enterprise system and/or the IQSC system. In various embodiments, data controller 504 may collect and utilize data from one or more other components of the enterprise system and/or the IQSC system to generate a knowledge base from which operational wisdom can be actualized (e.g., through operation of one or more of response analytics engine 506, dynamic relevance filter 508, root-cause engine 510, and various other components). In one embodiment, data controller 504 may annotate issues and corresponding resolutions.

In some embodiments, response analytics engine 506 may analyze data, such as from state monitor 302, to determine insight indexes and/or sets of indicators corresponding to insight indexes. In one embodiment, the response analytics engine 506 may utilize statistical analysis to identify new and useful insight indexes and corresponding indicators for quantization. In several embodiments, response analytics engine 506 may customize insight indexes and/or indicator sets on a per user basis.

In various embodiments, knowledge base manager 502 may perform root-cause analysis. For example, root-cause engine 510 may identify root causes of issues. The root causes may be utilized to generalized data regarding issues, user states, and the like in a manner that enables other users to benefit, such as by removing or reducing a root cause that manifests as multiple different issues. In some embodiments, root-cause engine 510 may be utilized to determine that one or more users are being charged unnecessary or excess fees. For instance, the root-cause engine 510 may determine processing transactions in an alternative manner can enable the user to avoid the unnecessary or excess fees.

FIG. 6 illustrates exemplary aspects of an issue forecaster 602 according to some embodiments. Generally, the issue forecaster 602 may forecast potential issues and set trigger thresholds. In the illustrated embodiment, the issue forecaster 602 includes a trigger threshold controller 604, an issue predicter 608, and a model manager 606. It will be appreciated that one or more components of FIG. 6 may be the same or similar to one or more other components disclosed hereby. For example, the issue forecaster 602 may be the same or similar to issue forecaster 210. Further, aspects discussed with respect to various components in FIG. 6 may be implemented by one or more other components from one or more other embodiments without departing from the scope of this disclosure. Embodiments are not limited in this context.

The components of issue forecaster 602 may operate to predict issues and determine relevant, appropriate, and/or recommended trigger thresholds, sets of indicators, sets of insight indexes, output actions, and the like). The issue forecaster 602 may utilize data from one or more other components of the enterprise system and/or the IQSC system. The trigger threshold controller 604 may determine various thresholds associated with one or more quantized insight index levels. The thresholds may indicate levels that are likely to result in an issue. In many embodiments, when a threshold is passed, a state improvement process may be triggered.

The issue predicter 608 may forecast issues resulting from insight index levels. In many embodiments, issue predicter 608 and/or trigger threshold controller 604 may utilize machine learning algorithms and/or knowledge graphs. In many embodiments, the statistical closeness of occurrences may be determined and used to identify similar situations and corresponding issues. In some embodiments, knowledge base manager 502 may provide relevant data to issue forecaster 602. In one embodiment, a knowledge graph may be utilized to identify relevant data. In one such embodiments, nodes in the knowledge graph may correspond to issues and edges may correspond to events, values, situations, and the like that lead to the issues.

The model manager 606 may manage and train machine learning models for use by various components of the IQSC system, such as trigger threshold controller 604 and issue predicter 608. In some embodiments, model manager 606 may interoperate with one or more of state simulator 312, root-cause engine 510, response analytics engine 506, state monitor 302, insight quantizer 402, knowledge base manager 502, and IQSC administrator 702 to generate accurate and reliable machine learning models. For example, model manager 606, state simulator 312, and response analytics engine 506 may work in conjunction to generate training data with accurate representations of statistical correlations.

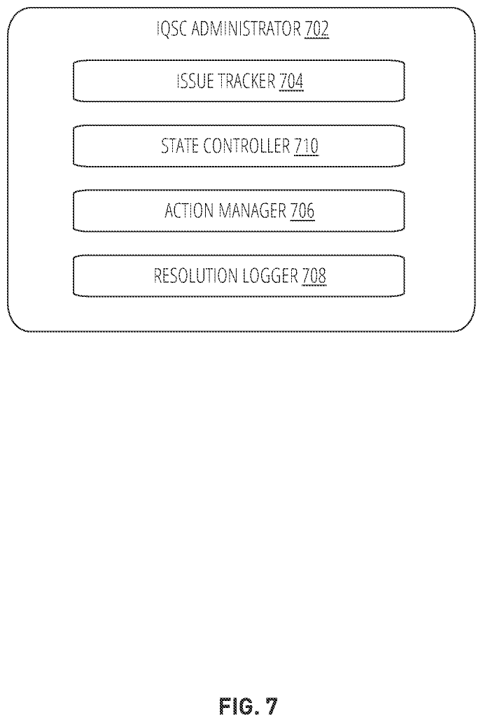

FIG. 7 illustrates exemplary aspects of an IQSC administrator 702 according to some embodiments. The IQSC administrator 702 may generally operate to track issues, implement mediating actions, and log resolutions. In the illustrated embodiment, the IQSC administrator 702 includes an issue tracker 704, an action manager 706, and a resolution logger 708. It will be appreciated that one or more components of FIG. 7 may be the same or similar to one or more other components disclosed hereby. For example, IQSC administrator 702 may be the same or similar to IQSC administrator 212. Further, aspects discussed with respect to various components in FIG. 7 may be implemented by one or more other components from one or more other embodiments without departing from the scope of this disclosure. Embodiments are not limited in this context.

The components of IQSC administrator 702 may track issues, implement mediating actions, and log resolutions. In various embodiments, IQSC administrator 702 may monitor and/or control other components of the IQSC system and/or enterprise system to track issues, implement mediating actions, and log resolutions. In several embodiments, issue tracker 704 may track potential issues and their statuses. State controller 710 may determine mediating output actions based on one or more of potential issues, quantized insight indexes, response analytics, relevant data, and root-causes. Action manager 706 may implement mediating output actions, such as by controlling one or more components of the enterprise system. For example, action manager 706 may increase air conditioning to reduce the temperature of an environment of the user. In another example, action manager 706 may implement soothing lighting or sounds. In yet another example, action manager 706 may provide or connect users to selected discounts, interfaces, customer service representatives, offers, privileges, prioritization, and the like.

Resolution logger 708 may track the effects of implemented mediating output actions. For example, resolution logger 708 may track the effects on one or more insight indexes and/or indicator values in response to mediating output actions. In many embodiments, this data may be analyzed and utilized by the knowledge base manager 502, such as to gain new insights and effective strategies for resolving or avoiding issues.

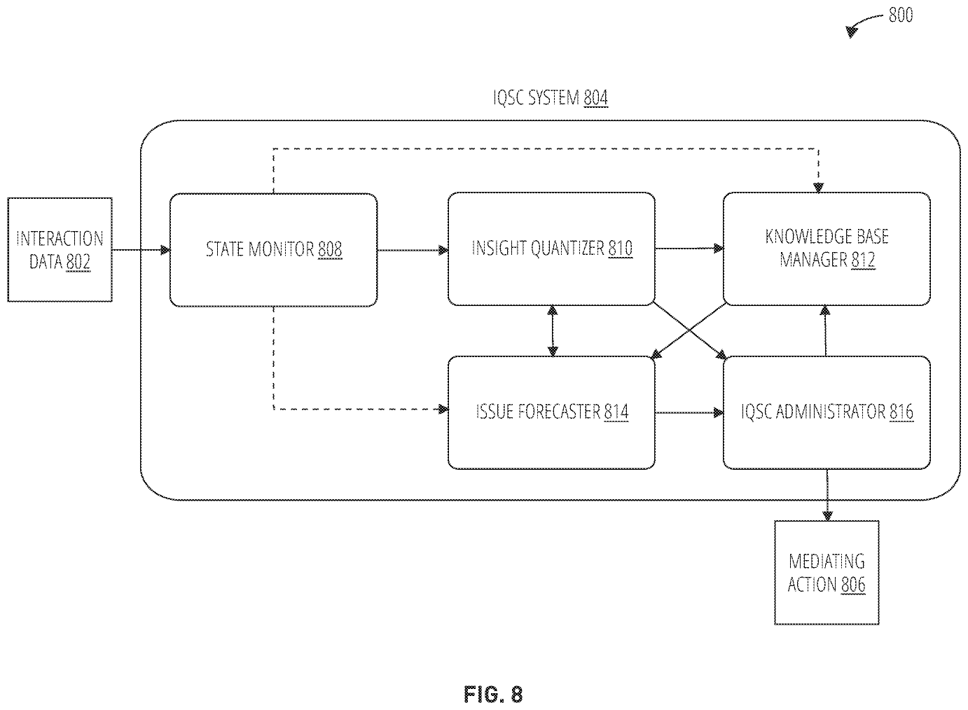

FIG. 8 illustrates a process flow 800 corresponding to an IQSC system 804 according to some embodiments. More specifically, process flow 800 may correspond to components of the IQSC system 804 interoperating to generate a mediating action 806 based on interaction data 802. In many embodiments, the mediating action 806 may be directed to controlling the state of a user corresponding to the interaction data 802. In the illustrated embodiment, the IQSC system 804 includes a state monitor 808, an insight quantizer 810, a knowledge base manager 812, an issue forecaster 814, and an IQSC administrator 816. It will be appreciated that one or more components of FIG. 8 may be the same or similar to one or more other components disclosed hereby. For example, IQSC system 804 may be the same or similar to IQSC system 102, state monitor 808 may be the same or similar to state monitor 302, insight quantizer 810 may be the same or similar to insight quantizer 402, knowledge base manager 812 may be the same or similar to knowledge base manager 502, issue forecaster 814 may be the same or similar to issue forecaster 602, and/or IQSC administrator 816 may be the same or similar to IQSC administrator 702. Further, aspects discussed with respect to various components in FIG. 8 may be implemented by one or more other components from one or more other embodiments without departing from the scope of this disclosure. Embodiments are not limited in this context.

The illustrated embodiment of process flow 800 provides an exemplary manner of operation for IQSC system 804. The state monitor 808 may receive interaction data 802 (e.g., from one or more components of the enterprise system. The state monitor 808 may provide indicator values to insight quantizer 810 for periodic and/or dynamic generation of quantized insight index values corresponding to users. The quantized insight indexes may be utilized by one or more of knowledge base manager 812, issue forecaster 814, and IQSC administrator 816 to forecast issues and generate mediating output actions to avoid or reduce the forecasted issues.

In one embodiment, IQSC system 804 may implement aspects of perceptual control theory. In one such embodiment the controlled various may be the quantized insight indexes and/or interaction data 802 and the mediating actions 806 may be directed to controlling the quantized insight index values and/or interaction data 802.

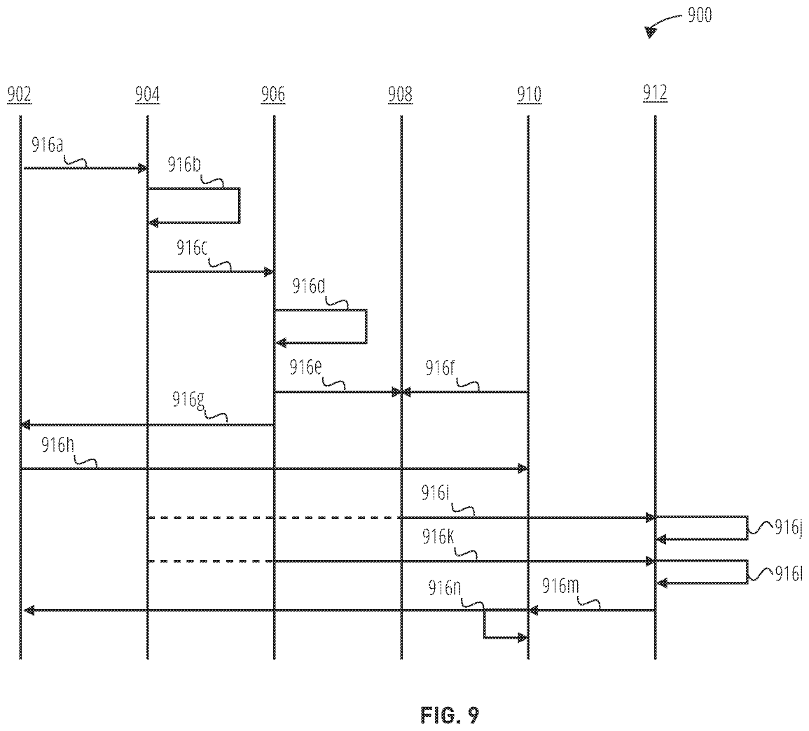

FIG. 9 illustrates a process diagram 900 corresponding to operation of components of an IQSC system in conjunction with an enterprise system 902 according to some embodiments. More specifically, process diagram 900 may correspond to processes performed by various components of an IQSC system for forecasting and avoiding or diffusing user issues. Many of the operations of process diagram 900 are automatically performed by the IQSC system. The process diagram 900 may include various processes involving one or more of an enterprise system 902, a state monitor 904, a situation quantizer 906, a knowledge base manager 908, an IQSC administrator 910, and an issue forecaster 912. It will be appreciated that one or more components of FIG. 9 may be the same or similar to one or more other components disclosed hereby. For example, enterprise system 902 may be the same or similar to enterprise system 106, state monitor 904 may be the same or similar to state monitor 302, situation quantizer 906 may be the same or similar to insight quantizer 402, knowledge base manager 908 may be the same or similar to knowledge base manager 502, issue forecaster 912 may be the same or similar to issue forecaster 602, and/or IQSC administrator 910 may be the same or similar to IQSC administrator 702. Further, aspects discussed with respect to various components in FIG. 9 may be implemented by one or more other components from one or more other embodiments without departing from the scope of this disclosure. Embodiments are not limited in this context.

Referring to FIG. 9, process diagram 900 may begin with process 916b. At process 916a, the state monitor 904 may receive indication from the enterprise system 902 that a user has initiated a transaction. At process 916b, the state monitor 904 may monitor the transaction in real-time or near real-time. Continuing to process 916c, as the transaction is in process, user behavior may change. This change is indicated to situation quantizer 906 by state monitor 904, such as via indicator values and/or context data.

Proceeding to process 916d, the situation quantizer 906 may utilize an intelligent artificial intelligence and/or machine learning system that scores and predicts the behavior on one or more quantized insight indexes. In various embodiments, the one or more quantized insight indexes may correspond to a user patience index. For instances, if the average wait time before complaining is 3 minutes, the system will implement a state improvement process when 3 minutes is approaching to reduce or avoid the complaint. In some such instances, the state improvement process may result in a mediating output action that connects the user with a live customer service representative.

At process 916e, the knowledge base manager 908 may read and analyze behavioral scores (e.g., insight indexes). At process 916f, the knowledge base manager 908 may read, analyze, and/or determine relevant complaints and resolutions (e.g., via dynamic relevance filter 508). Continuing to process 916g, user behavior triggers may cause implementation of a state improvement process using the enterprise system 902. In several embodiments, a potential issue may be identified and/or raised. At process 916h, the potential complaint on the transaction may be recorded at situation quantizer IQSC administrator 910 (e.g., via issue tracker 704).

At process 916i, the data may be provided to the issue forecaster 912 by knowledge base manager 908. At process 916k, the situation quantizer 906 may provide patience index values corresponding to the user (i.e., one or more quantized insight indexes) to the issue forecaster 912. Proceeding to process 916j, the issue forecaster 912 may utilize data provided by knowledge base manager 908 to identify relevant historical data. At process 916l, the issue forecaster 912 may utilize quantized insight index values data provided by situation quantizer 906 to generate ranked/suggested/recommended mediating output actions. Continuing to process 916m, the ranked/suggested/recommended mediating output actions may be provided to IQSC administrator 910 for implementation. At process 916a the IQSC administrator 910 selects and implements mediating output actions via one or more components of enterprise system 902.

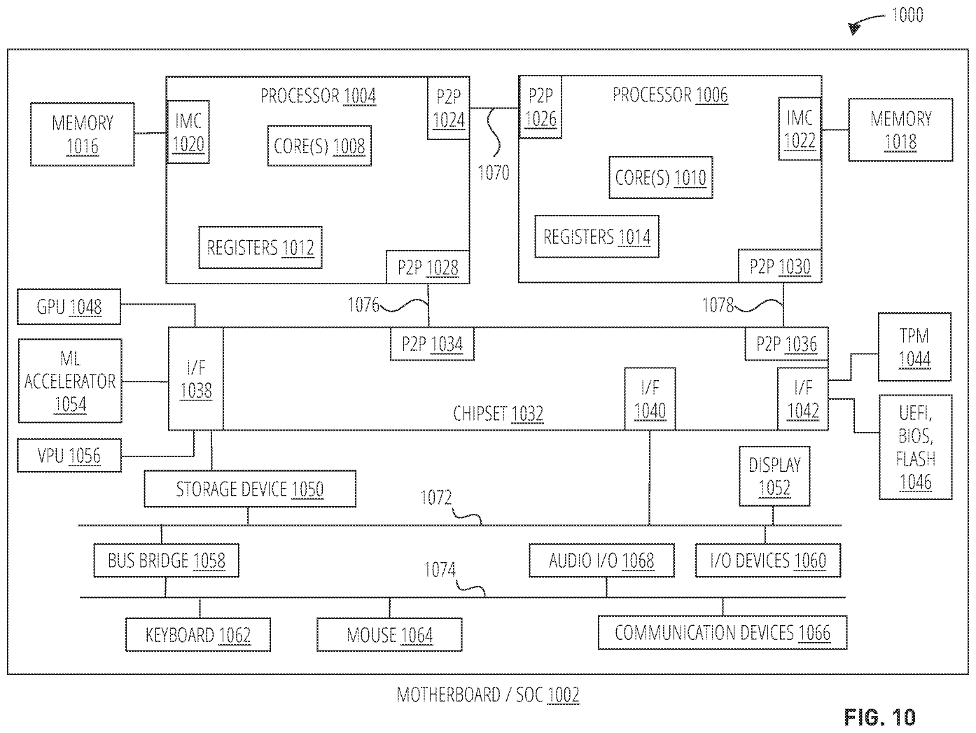

FIG. 10 illustrates an embodiment of a system 1000 that may be suitable for implementing various embodiments described hereby. System 1000 is a computing system with multiple processor cores such as a distributed computing system, supercomputer, high-performance computing system, computing cluster, mainframe computer, mini-computer, client-server system, personal computer (PC), workstation, server, portable computer, laptop computer, tablet computer, handheld device such as a personal digital assistant (PDA), or other device for processing, displaying, or transmitting information. Similar embodiments may comprise, e.g., entertainment devices such as a portable music player or a portable video player, a smart phone or other cellular phone, a telephone, a digital video camera, a digital still camera, an external storage device, and the like. Further embodiments implement larger scale server configurations. In other embodiments, the system 1000 may have a single processor with one core or more than one processor. Note that the term “processor” refers to a processor with a single core or a processor package with multiple processor cores. In at least one embodiment, the computing system 1000, or one or more components thereof, is representative of one or more components described hereby, such as IQSC system 102, enterprise system 106, and/or components thereof . . . . More generally, the computing system 1000 may be configured to implement embodiments including logic, systems, logic flows, methods, apparatuses, and functionality described hereby. The embodiments, however, are not limited to implementation by the system 1000.

As used in this application, the terms “system” and “component” and “module” are generally intended to refer to a computer-related entity, either hardware, a combination of hardware and software, software, or software in execution, examples of which are provided by the exemplary system 1000. For example, a component can be, but is not limited to being, a process running on a processor, a processor, a hard disk drive, multiple storage drives (of optical, solid-state, and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

Although not necessarily illustrated, the computing system 1000 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. Further, the computing system 1000 may include or implement various articles of manufacture. An article of manufacture may include a non-transitory computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, encrypted code, and the like, implemented using any suitable high-level, low-level, object-oriented, visual, compiled, and/or interpreted programming language. Embodiments may also be at least partly implemented as instructions contained in or on a non-transitory computer-readable medium, which may be read and executed by one or more processors to enable performance of the operations described herein.

As illustrated in FIG. 10, the system 1000 comprises a motherboard or system-on-chip (SoC) 1002 for mounting platform components. Motherboard or system-on-chip (SoC) 1002 is a point-to-point (P2P) interconnect platform that includes a first processor 1004 and a second processor 1006 coupled via a point-to-point interconnect 1070 such as an Ultra Path Interconnect (UPI). In other embodiments, the system 1000 may be of another bus architecture, such as a multi-drop bus. Furthermore, each of processor 1004 and processor 1006 may be processor packages with multiple processor cores including core(s) 1008 and core(s) 1010, respectively. While the system 1000 is an example of a two-socket (2S) platform, other embodiments may include more than two sockets or one socket. For example, some embodiments may include a four-socket (4S) platform or an eight-socket (8S) platform. Each socket is a mount for a processor and may have a socket identifier. Note that the term platform refers to the motherboard with certain components mounted such as the processor 1004 and chipset 1032. Some platforms may include additional components and some platforms may only include sockets to mount the processors and/or the chipset. Furthermore, some platforms may not have sockets (e.g., SoC, or the like).

The processor 1004 and processor 1006 can be any of various commercially available processors. Dual microprocessors, multi-core processors, and other multi-processor architectures may also be employed as the processor 1004 and/or processor 1006. Additionally, the processor 1004 need not be identical to processor 1006.

Processor 1004 includes an integrated memory controller (IMC) 1020 and point-to-point (P2P) interface 1024 and P2P interface 1028. Similarly, the processor 1006 includes an IMC 1022 as well as P2P interface 1026 and P2P interface 1030. IMC 1020 and IMC 1022 couple the processors processor 1004 and processor 1006, respectively, to respective memories (e.g., memory 1016 and memory 1018). Memories 1016, 1018 can store instructions executable by circuitry of system 1000 (e.g., processor 1004, processor 1006, graphics processing unit (GPU) 1048, ML accelerator 1054, vision processing unit (VPU) 1056, or the like). For example, memories 1016, 1018 can store instructions for one or more of IQSC system 102, enterprise system 106, state monitor 302, insight quantizer 402, knowledge base manager 502, issue forecaster 602, IQSC administrator 702, and the like. In another example, memories 1016, 1018 can store data, such as interaction data 802, user data, historical data, ML/AI models, training data, and the like. Memory 1016 and memory 1018 may be portions of the main memory (e.g., a dynamic random-access memory (DRAM)) for the platform such as double data rate type 3 (DDR3) or type 4 (DDR4) synchronous DRAM (SDRAM). In the present embodiment, the memory 1016 and memory 1018 locally attach to the respective processors (i.e., processor 1004 and processor 1006). In other embodiments, the main memory may couple with the processors via a bus and/or shared memory hub.

System 1000 includes chipset 1032 coupled to processor 1004 and processor 1006. Furthermore, chipset 1032 can be coupled to storage device 1050, for example, via an interface (I/F) 1038. The I/F 1038 may be, for example, a Peripheral Component Interconnect-enhanced (PCI-e). In many embodiments, storage device 1050 comprises a non-transitory computer-readable medium. Storage device 1050 can store instructions executable by circuitry of system 1000 (e.g., processor 1004, processor 1006, GPU 1048, ML accelerator 1054, vision processing unit 1056, or the like). For example, storage device 1050 can store instructions for one or more of IQSC system 202, state monitor 808, issue forecaster 814, enterprise system 902, situation quantizer 906, IQSC administrator 910, and the like. In another example, storage device 1050 can store data, such as interaction data 802, user data, historical data, simulated data, ML/AI models, training data, monitoring data, and the like. In some embodiments, instructions may be copied or moved from storage device 1050 to memory 1016 and/or memory 1018 for execution, such as by processor 1004 and/or processor 1006.

Processor 1004 couples to a chipset 1032 via P2P interface 1028 and P2P interface 1034 while processor 1006 couples to a chipset 1032 via P2P interface 1030 and P2P interface 1036. Direct media interface (DMI) 1076 and DMI 1078 may couple the P2P interface 1028 and the P2P interface 1034 and the P2P interface 1030 and P2P interface 1036, respectively. DMI 1076 and DMI 1078 may be a high-speed interconnect that facilitates, e.g., eight Giga Transfers per second (GT/s) such as DMI 3.0. In other embodiments, the components may interconnect via a bus.

The chipset 1032 may comprise a controller hub such as a platform controller hub (PCH). The chipset 1032 may include a system clock to perform clocking functions and include interfaces for an I/O bus such as a universal serial bus (USB), peripheral component interconnects (PCIs), serial peripheral interconnects (SPIs), integrated interconnects (I2Cs), and the like, to facilitate connection of peripheral devices on the platform. In other embodiments, the chipset 1032 may comprise more than one controller hub such as a chipset with a memory controller hub, a graphics controller hub, and an input/output (I/O) controller hub.

In the depicted example, chipset 1032 couples with a trusted platform module (TPM) 1044 and UEFI, BIOS, FLASH circuitry 1046 via I/F 1042. The TPM 1044 is a dedicated microcontroller designed to secure hardware by integrating cryptographic keys into devices. The UEFI, BIOS, FLASH circuitry 1046 may provide pre-boot code.

Furthermore, chipset 1032 includes the I/F 1038 to couple chipset 1032 with a high-performance graphics engine, such as, graphics processing circuitry or a graphics processing unit (GPU) 1048. In other embodiments, the system 1000 may include a flexible display interface (FDI) (not shown) between the processor 1004 and/or the processor 1006 and the chipset 1032. The FDI interconnects a graphics processor core in one or more of processor 1004 and/or processor 1006 with the chipset 1032.

Additionally, ML accelerator 1054 and/or vision processing unit 1056 can be coupled to chipset 1032 via I/F 1038. ML accelerator 1054 can be circuitry arranged to execute ML related operations (e.g., training, inference, etc.) for ML models (e.g., in one or more of insight quantizer 206, knowledge base manager 208, and issue forecaster 210). Likewise, vision processing unit 1056 can be circuitry arranged to execute vision processing specific or related operations. In particular, ML accelerator 1054 and/or vision processing unit 1056 can be arranged to execute mathematical operations and/or operands useful for machine learning, neural network processing, artificial intelligence, vision processing, etc. In one embodiment, vision processing may be utilized, such as in combination with cameras, to determine values for indicators corresponding to one or more quantized insight indexes. For example, values for indicators may be based on facial expressions of a user.

Various I/O devices 1060 and display 1052 couple to the bus 1072, along with a bus bridge 1058 which couples the bus 1072 to a second bus 1074 and an I/F 1040 that connects the bus 1072 with the chipset 1032. In one embodiment, the second bus 1074 may be a low pin count (LPC) bus. Various I/O devices may couple to the second bus 1074 including, for example, a keyboard 1062, a mouse 1064, and communication devices 1066.

Furthermore, an audio I/O 1068 may couple to second bus 1074. Many of the I/O devices 1060 and communication devices 1066 may reside on the motherboard or system-on-chip (SoC) 1002 while the keyboard 1062 and the mouse 1064 may be add-on peripherals. In other embodiments, some or all the I/O devices 1060 and communication devices 1066 are add-on peripherals and do not reside on the motherboard or system-on-chip (SoC) 1002. More generally, the I/O devices of system 1000 may include one or more of microphones, speakers, infra-red (IR) remote controls, radio-frequency (RF) remote controls, game pads, stylus pens, card readers, dongles, fingerprint readers, gloves, graphics tablets, joysticks, keyboards, retina readers, touch screens (e.g., capacitive, resistive, etc.), trackballs, track pads, sensors, styluses, displays, augmented/virtual reality devices, printers, actuators, motors, transducers, and the like.

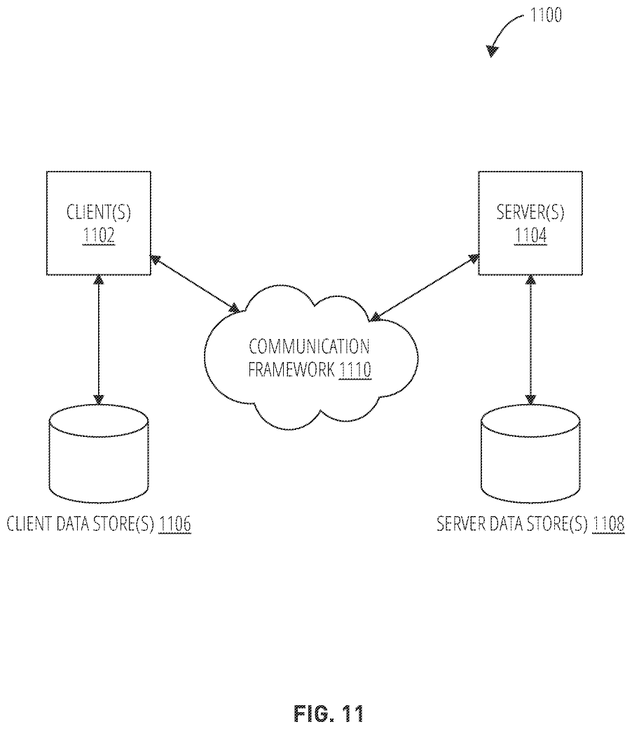

FIG. 11 is a block diagram depicting an exemplary communications architecture 1100 suitable for implementing various embodiments as previously described, such as communications between one or more of IQSC system 102, user 104, and enterprise system 106. The communications architecture 1100 includes various common communications elements, such as a transmitter, receiver, transceiver, radio, network interface, baseband processor, antenna, amplifiers, filters, power supplies, and so forth. The embodiments, however, are not limited to implementation by the communications architecture 1100.

As shown in FIG. 11, the communications architecture 1100 includes one or more client(s) 1102 and server(s) 1104. In some embodiments, each client 1102 and/or server 1104 may include a computing system (e.g., system 1000) The server(s) 1104 may implement one or more devices of IQSC system 102 and/or enterprise system 106. The client(s) 1102 and the server(s) 1104 are operatively connected to one or more respective client data store(s) 1106 and server data store(s) 1108 that can be employed to store information local to the respective client(s) 1102 and server(s) 1104, such as cookies and/or associated contextual information. In various embodiments, any one of server(s) 1104 may implement one or more logic flows or operations described hereby, such as in conjunction with storage of data received from any one of client(s) 1102 on any of server data store(s) 1108. In one or more embodiments, one or more of client data store(s) 1106 or server data store(s) 1108 may include memory accessible to one or more portions of components, applications, and/or techniques described hereby.

The client(s) 1102 and the server(s) 1104 may communicate information between each other using a communication framework 1110. The communication framework 1110 may implement any well-known communications techniques and protocols. The communication framework 1110 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communication framework 1110 may implement various network interfaces arranged to accept, communicate, and connect to a communications network. A network interface may be regarded as a specialized form of an input/output (I/O) interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.7a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount of speed and capacity, distributed network controller architectures may similarly be employed to pool, load balance, and otherwise increase the communicative bandwidth required by client(s) 1102 and the server(s) 1104. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate.

The various devices, components, modules, features, and functionalities described hereby may include, or be implemented via, various hardware elements, software elements, or a combination of both. Examples of hardware elements may include devices, logic devices, hardware components, processors, microprocessors, circuits, circuitry, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, algorithms, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds, and other design or performance constraints, as desired for a given implementation. It is noted that hardware, firmware, and/or software elements may be collectively or individually referred to herein as “logic”, “circuit”, or “circuitry”.

One or more aspects of at least one embodiment may be implemented by representative instructions stored on a machine-readable medium which represents various logic within the processor, which when read by a machine causes the machine to fabricate logic to perform the techniques described hereby. Such representations, known as “IP cores” may be stored on a tangible, machine readable medium and supplied to various customers or manufacturing facilities to load into the fabrication machines that actually make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, and the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, and the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, and the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include digital computers or similar devices.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

1. A computer-implemented method, comprising:
determining a context of a user with respect to an enterprise system;
selecting a quantized insight index relevant to a current situation of the user based on the context of the user;
monitoring values of a set of indicators corresponding to the quantized insight index and the user;
generating a current value of the quantized insight index for the user based on current values of the set of indicators corresponding to the quantized insight index;
triggering a performance of a state improvement process in response to comparison of the current value of the quantized insight index to the trigger threshold, the performance of the state improvement process including:
utilizing the current value of the quantized insight index as input to forecast an issue,
generating a mediating output action configured to adjust the current value of the quantized insight index and reduce or avoid the issue, and
implementing the mediating output action;
updating values of the set of parameters corresponding to the user of the enterprise system;
generating an updated value of the quantized insight index based on updated values of the set of indicators corresponding to the quantized insight index; and
determining performance of another state improvement process is unnecessary in response to comparison of the updated value of the quantized insight index to the trigger threshold.

2. The computer-implemented method of claim 1, wherein the quantized insight index corresponds to a patience level of the user.

3. The computer-implemented method of claim 1, wherein the context of the user includes one or more of a product type, a service type, an interface type, a transaction type, and a front-end component type.

4. The computer-implemented method of claim 1, wherein the set of indicators that the quantized insight index is based on include one or more of a connection time, a noise level, grammar characteristics, a wait time, input characteristics, a temperature, facial expressions, body language, and voice characteristics.

5. The computer-implemented method of claim 1, further comprising setting the trigger threshold based on the context of the user, the quantized insight index relevant to the current situations of the user, user data, and a knowledge base of historical situations, wherein the historical situations include historical occurrences of issues associated with the current situation of the user and historical values of the quantized insight index at the historical occurrences of the issues.

6. The computer-implemented method of claim 1, wherein the values associated with the user for the set of indicators that the quantized insight index is based on are monitored via one or more sensors including one or more of a temperature sensor, a camera, a timer, a key logger, and a microphone.

7. The computer-implemented method of claim 1, wherein implementing the mediating output action includes controlling one or more components of the enterprise system to produce an output directed to the user.

8. The computer-implemented method of claim 1, wherein a machine learning model trained on historical occurrences of issues associated with the current situation of the user and historical values of the quantized insight index at the historical occurrences of the issues utilizes the current value of the quantized insight index as input to forecast the issue.

9. An apparatus comprising:
a processor; and
memory storing instructions that, when executed by the processor, cause the processor to:
determine a context of a user with respect to an enterprise system;
select a quantized insight index relevant to a current situation of the user based on the context of the user;
monitor values of a set of indicators corresponding to the quantized insight index and the user;
generate a current value of the quantized insight index for the user based on current values of the set of indicators corresponding to the quantized insight index;
trigger a performance of a state improvement process in response to comparison of the current value of the quantized insight index to the trigger threshold, the performance of the state improvement process including:
utilize the current value of the quantized insight index as input to forecast an issue,
generate a mediating output action configured to adjust the current value of the quantized insight index and reduce or avoid the issue, and
implement the mediating output action;
update values of the set of parameters corresponding to the user of the enterprise system;
generate an updated value of the quantized insight index based on updated values of the set of indicators corresponding to the quantized insight index; and
determine performance of another state improvement process is unnecessary in response to comparison of the updated value of the quantized insight index to the trigger threshold.

10. The apparatus of claim 9, wherein the quantized insight index corresponds to a patience level of the user.

11. The apparatus of claim 9, wherein the context of the user includes one or more of a product type, a service type, an interface type, a transaction type, and a front-end component type.

12. The apparatus of claim 9, wherein the set of indicators that the quantized insight index is based on include one or more of a connection time, a noise level, grammar characteristics, a wait time, input characteristics, a temperature, facial expressions, body language, and voice characteristics.

13. The apparatus of claim 9, wherein the memory further stores instructions that, when executed by the processor, cause the processor to set the trigger threshold based on the context of the user, the quantized insight index relevant to the current situations of the user, user data, and a knowledge base of historical situations, wherein the historical situations include historical occurrences of issues associated with the current situation of the user and historical values of the quantized insight index at the historical occurrences of the issues.

14. The apparatus of claim 9, wherein the values associated with the user for the set of indicators that the quantized insight index is based on are monitored via one or more sensors including one or more of a temperature sensor, a camera, a timer, a key logger, and a microphone.

15. The apparatus of claim 9, wherein implementation of the mediating output action includes controlling one or more components of the enterprise system to produce an output directed to the user.

16. The apparatus of claim 9, wherein a machine learning model trained on historical occurrences of issues associated with the current situation of the user and historical values of the quantized insight index at the historical occurrences of the issues utilizes the current value of the quantized insight index as input to forecast the issue.

17. At least one non-transitory computer-readable storage medium storing computer-executable program code instructions that, when executed by a computing apparatus, cause the computing apparatus to:
determine a context of a user with respect to an enterprise system;
select a quantized insight index relevant to a current situation of the user based on the context of the user;
monitor values of a set of indicators corresponding to the quantized insight index and the user;
generate a current value of the quantized insight index for the user based on current values of the set of indicators corresponding to the quantized insight index;
trigger a performance of a state improvement process in response to comparison of the current value of the quantized insight index to the trigger threshold, the performance of the state improvement process including:
utilize the current value of the quantized insight index as input to forecast an issue,
generate a mediating output action configured to adjust the current value of the quantized insight index and reduce or avoid the issue, and
implement the mediating output action;
update values of the set of parameters corresponding to the user of the enterprise system;
generate an updated value of the quantized insight index based on updated values of the set of indicators corresponding to the quantized insight index; and
determine performance of another state improvement process is unnecessary in response to comparison of the updated value of the quantized insight index to the trigger threshold.

18. The at least one non-transitory computer-readable storage medium of claim 17, wherein the quantized insight index corresponds to a patience level of the user.

19. The at least one non-transitory computer-readable storage medium of claim 17, wherein the set of indicators that the quantized insight index is based on include one or more of a connection time, a noise level, grammar characteristics, a wait time, input characteristics, a temperature, facial expressions, body language, and voice characteristics.

20. The at least one non-transitory computer-readable storage medium of claim 17, wherein the memory further stores instructions that, when executed by the processor, cause the processor to set the trigger threshold based on the context of the user, the quantized insight index relevant to the current situations of the user, user data, and a knowledge base of historical situations, wherein the historical situations include historical occurrences of issues associated with the current situation of the user and historical values of the quantized insight index at the historical occurrences of the issues.
